(19) United States
(12) Patent Application Publication
(10) Pub. No.: US 2025/0001690 A1
(43) Pub. Date: Jan. 2, 2025

(54) METHOD AND COMPOSITION FOR REDEPLOYING A POLYMER FEEDSTOCK

(71) Applicant: 3D Systems, Inc., Rock Hill, SC (US)

(72) Inventors: Vincent Lesney, Rock Hill, SC (US); Meisam Shir Mohammadi, Charlotte, NC (US); Mitchell Donald Von Behren, Castle Rock, CO (US)

(21) Appl. No.: 18/758,614

(22) Filed: Jun. 28, 2024

Related U.S. Application Data
(60) Provisional application No. 63/510,916, filed on Jun. 29, 2023.

(51) Int. Cl. B29C 64/357; B29K 77/00; B29K 105/00; B29K 105/12; B29K 507/04; B33Y 70/00

(52) U.S. Cl. CPC B29C 64/357; B33Y 70/00; B29K 2077/00; B29K 2105/12; B29K 2105/251; B29K 2507/04

(57) ABSTRACT

Disclosed are techniques for converting polymeric powder that has been discarded from a powder bed fusion process into a raw material suitable for an alternative form of additive manufacturing involving extruded deposition. As applied to polyamide powders, the disclosed methods improve suitability of the material for an extrusion process by adding another polyamide species in which the spacings between functional groups on the polymer chain do not follow a repeating pattern. In at least one preferred embodiment, a fibrous filler is also added to further improve dimensional compliance and stability in parts formed by depositing extruded beads of the inventive composition.

### TECHNICAL FIELD

The present invention pertains to thermoplastic compositions for extrusion-type additive manufacturing and, more particularly, to converting an exhausted powder feedstock from a powder bed fusion process for redeployment as a feedstock for extruded deposition.

### BACKGROUND

In the field of additive manufacturing, various types of thermoplastics have been widely used as feedstock materials from which to form three-dimensional objects. In one such type of additive manufacturing process, a form of powder bed fusion (PBF) called selective laser sintering (SLS), space-occupying rigid structures are formed from a powdered starting material by using a laser to heat and fuse selected portions of the powder.

In an SLS process, unconsolidated loose powder is spread into a uniform thin layer within a heated chamber or vat and receives a patterned exposure to laser light to cause areas of the powder to fuse together. This process is repeated numerous times so that the volume of the chamber is eventually filled both with loose powder and with one or more objects or workpieces that have been progressively formed layer-by-layer and that are embedded within the powder. During this entire process, the temperature of the chamber is carefully maintained between melting and crystallization temperatures for the build material so that uniform fusion occurs precisely where the laser radiation has been directed. Once all layers have been placed and irradiated where needed, the chamber is very slowly cooled so that the locally liquefied portions of the powder fully fuse and solidify.

Powdered polyamides such as nylon 12 are commonly used for SLS. Though the powdered raw material comes to occupy the complete volume of the vat, only a portion of the material in the vat becomes fused by radiation heating and the remainder is sloughed off when, upon completion of the build, one or more finished parts are pulled from the container and separated from the unfused powder particles, also referred to as ‘partcake’. To a limited extent, this unfused powder may be recycled for subsequent runs. However, as recycled powder particles are subjected to repeated cycles of SLS processing, their physical shape and molecular structure degrade to the point that their subsequent inclusion in an SLS process can significantly undermine part quality. Poor powder quality can lead to curling caused by shrinkage, roughened surface textures due to clumping, deviation in part contour adherence and gaps or voids as the powder is being spread.

The unfused portion of powder that falls away upon part removal often accounts for 80-90% of the container volume and can only be recycled to a limited extent, even when mixed with some proportion of fresh material. Depending on material type and manufacturer, the recommended proportion of virgin material to be mixed with recycled material ranges from 20% to 50%.

Consequently, a significant mass of the expensive powder that was specially formulated and granulated to suit SLS processing must be discarded at some point. For example, an SLS process involving an overall batch mass of 20 kg may result in a 5 kg discarded mass on average, at a cost of USD180 per kg. This cost must be factored into the unit cost for SLS-produced parts. Further measures are needed to reclaim or otherwise reduce the economic and environmental impact of this waste material.

### SUMMARY

The present disclosure relates to converting polymeric powder that has been discarded from an SLS process into a raw material suitable for an alternative form of additive manufacturing, such as by extruded deposition. In particular, the present teachings are illustrated by example using polyamide powders as the principal components to form a new polymeric composition by combination with a filler material and small amount of a second polyamide having a molecular structure that features non-periodically spaced amide functional groups. The latter component overcomes difficulties (such as poor inter-layer adhesion and excessive extruder torque) with using the discarded polyamide polymers directly as feedstocks for extrusion deposition while improving mechanical properties and consistency thereof. The filler material complements the combination by mitigating certain characteristics imparted by the second polyamide that would otherwise hinder usefulness in an extrusion deposition process.

As it is advantageous to reclaim a maximum amount of spent material by adding a minimal amount of one or more new materials. In some embodiments to be explained herein, the second polyamide mentioned above may also have been previously used as an SLS powder so a proper combination of two particular species of spent polymer may yield a formulation suitable for extrusion deposition with the addition of only a filler.

It is contemplated that a manufacturer, or parties collectively in a manufacturing ecosystem, may procure and use polymer powders for SLS processing in anticipation of also supplying extrusion deposition processes. Because extrusion production provides an alternative pathway to outputting product and recouping material costs, this relaxes the cost-driven pressure to maximally recycle used powders in SLS processing.

### BRIEF DESCRIPTION OF THE DRAWINGS

Various exemplary embodiments are illustrated by way of example, and not by way of limitation, in the following detailed description, claims and accompanying drawings, in which like reference numerals refer to similar elements and in which:

FIG. 1 is a pictorial showing a typical extrusion additive manufacturing system that may use a feedstock material prepared in accordance with the present teachings;

FIG. 2 is a diagram of a pellet-fed extruder for use in an additive manufacturing system;

FIG. 3 is a block diagram depicting a drive train for a pellet-fed extruder and indicating various points for monitoring torque applied to discharge molten material from a nozzle;

FIG. 4 is a graph of observed extruder torque plotted as a function of a proportion of an inhibited crystallization polymer that has been combined with a spent polymer from a selective laser sintering process;

FIG. 5 is a sketch depicting the crystalline structure of a polyamide species and a regular pattern of hydrogen bonding among functional groups on proximal chain segments;

FIG. 6 is a diagram showing irregular hydrogen bonding among polyamide molecules having regular spacings of functional groups and inhibited crystallization polymer molecules having non-repeating spacings of functional groups as may occur within a composition formed in accordance with exemplary embodiments of the present teachings;

FIGS. 7A-7D are four conceptual diagrams depicting the operation of plasticizing approaches including a novel principle for plasticizing using an inhibited crystallization polymer in accordance with preferred embodiments of the present teachings;

FIG. 8 is a diagram presenting views that describe how a crystalline domain in a polymer may transition into a less crystalline form as stabilized by addition of an inhibited crystallization polymer in accordance with preferred embodiments of the present teachings; and

FIG. 9 is a diagram depicting the lifecycle of a polymer material in accordance with preferred embodiments of the present teachings.

### DETAILED DESCRIPTION

In the following description, for the purposes of explanation, numerous specific details are set forth to provide a thorough understanding of illustrative and preferred embodiments of the invention. It should be understood, however, that some embodiments may be practiced without all of the specific details mentioned or with alternative, equivalent arrangements. In some instances, more common structures and devices are excluded from view or shown in block diagram form in order to avoid unnecessarily obscuring components that are more essential for illustrating embodiments of the invention and its operating principles.

As used in the present specification and accompanying claims, the words ‘comprises’ and ‘comprising’ mean ‘including at least’ and, unless otherwise specified in context, do not exclude the possibility of additional elements, attributes, components, members or ingredients.

As used herein, the term ‘molten’ is loosely applied to any state of a material when it is heated or otherwise softened and is ‘flowable’, meaning of sufficiently low viscosity to flow through a small nozzle under pressure. It is recognized that for some materials a more precise terminology, such as a ‘plastic’ or ‘amorphous’ states or other phase transitions occurring upon attainment of a given temperature, may be more commonly used and the term ‘molten’ is intended to encompass these situations. When a material is said to be ‘molten’ herein it will generally be at a temperature substantially above its glass transition (T_{g}) temperature, where applicable. For semi-crystalline materials, the ‘molten’ temperature will also generally be above both the cold and hot temperature limits within which crystallization may develop.

A first type of polymer species may be referred to herein as a ‘regular repeat polymer’ or ‘periodic polymer’ characterized by having, in its chain molecular structure, a consistently repeating pattern of functional groups and intervening methylene (—CH2-) units. An example of a regular repeat polymer is polyamide 12 (PA12 or nylon 12) wherein amide functional groups are regularly spaced along the length of the molecule, with eleven methylene units and one carbonyl unit (12 carbons total) between each recurring secondary amine moiety. As another example, a PA6/12 molecule comprises alternating intervals of 6 and 12 carbons, so there is again a regular and predictably repeating pattern of functional group occurrence along the length of the molecule.

A second type of polymer species may be referred to herein as an ‘aperiodic polymer’ in which the molecular structure comprises functional groups and intervening methylene units that do not occur in a fixed, repeating pattern over the length of the polymer chain. An example of an aperiodic polymer is a polyamide in which secondary amine groups along the chain are separated by either six or twelve carbons but the occurrence of either a 6-carbon spacing or 12-carbon spacing within a given interval is completely random. This structure lacks a predictably repeating pattern of functional group occurrences over the length of the molecule.

To facilitate an understanding of the present invention, the following description provides a brief overview of both powder bed fusion and extrusion additive manufacturing processes while explaining how a class of thermoplastics, chemically similar but having some disparate structural characteristics, may be used to better adapt a discarded feedstock from the former process for use by the latter process in accordance with illustrative embodiments.

Using the powder bed fusion process, an object is formed by applying a polymer powder in a thin layer to a vertically movable plate of a sintering chamber, which is normally heated to a temperature slightly below the melting point of the given polymer and slightly above its solidification or crystallization point. The laser selectively sinters the powder particles in a pattern as directed by a controlling computer. After that, the movable plate is lowered by the amount of the layer thickness, usually 0.05 to 2.0 mm. With the application of a new powder layer, the process is repeated. After the completion of a preselected number of cycles according to the intended number of layers, a block has been formed which mainly consists of powder at the periphery. Within the powder is held a highly viscous melt or a mostly solidified block in the shape of the desired object. Non-melted areas where the powder is still in a solid but unfused form stabilize the shape of the melt before it has solidified. After that, the block consisting of the powder ‘shell’ and the melted portions is slowly cooled, and the melt solidifies as it falls below the solidification temperature of the polymer.

Preferred industry practice is to keep the block near a solidification temperature until the phase transformation is completed. This is achieved by selecting a low cooling rate in the temperature range of the phase transformation, so that the released heat of solidification keeps the molded body inside at exactly the solidification temperature until the phase transformation is completed. After cooling, often over a period of 1-2 days, the block is removed from the sintering chamber and the object formed by fusion is separated from any remaining unsolidified polymer powder. Depending on the collective volume occupied by the parts being built by the fusion process, the amount of powder that becomes fused and solidified to form a part may only constitute 10-20% of the build volume, or perhaps a higher percentage when a multitude of high-density parts can be tightly packed or interleaved and processed in a single build cycle.

For successful builds, particles in SLS powders are preferably spherical and smooth so that they flow and spread evenly, in a fluid-like manner, without leaving voids. Furthermore, SLS material must exhibit low viscosity and surface tension when energized by photonic radiation so that, coupled with careful regulation of processing temperatures, laser radiation causes localized melting in a controlled manner and heated particles fuse to other adjoining irradiated portions alongside and underneath.

A common procedure used to separate a finished part from the surrounding unfused material involves vacuuming out or otherwise clearing away powder until the part can be reached, lifting the newly formed part and giving it a light tap to dislodge any unattached powder. Any powder that falls loose under gravity, tilting or light agitation may have been untouched by photonic radiation but has nevertheless been subjected to temperature cycling that gradually changes crystalline structure and thermal behavior of the powder. In contrast, particles that remain attached to the fused surface, though removable with slight coercion, are more likely to be deformed or structurally modified and are therefore too risky to continue reusing in further SLS builds. For this reason, the fractions of powdered materials that more strongly cling to the part are brushed off to get to the true contour surface of the part and then these scrapings are usually discarded offhand as being wholly unsuitable for further SLS processing. Attempting to reuse these irregular particles, and clumps thereof, may interfere with spreading or flowing of the powder for other builds and result in subsequent parts having random voids or surface aberrations.

Aside from this incidental clumping effect, the temperature cycling experienced during SLS processing causes degradation, aging or development of high crystallinity in commonly used materials, such as nylon 12, and eventually renders a powder polymer unusable for repeated processing. For this reason, suppliers of powdered nylon for SLS recommend a minimum percentage of virgin material to add when recycling powder. Even then, used powder particles cannot be recycled indefinitely.

Common species of thermoplastics used for SLS, notably nylon 12, comprise polymer chains with regularly spaced functional groups causing adjacent chains of this polymer to very strongly engage in mutual hydrogen bonding. This may correspond to a ‘regular polymer’ as introduced earlier. Polymers having regularly spaced functional groups tend to achieve comparatively high degrees of crystallinity, to retain considerable crystallinity at elevated temperatures and to readily restore increased crystallinity as they cool after reaching higher temperatures as may be needed to achieve a molten, flowable or fusible state. Given the regularity and frequency of functional groups along each polymer chain, a mass of such chains can readily settle into an optimum alignment of polar functional groups and achieve a corresponding lower energy state. Nylon 12 is generally regarded as semi-crystalline polymer in that it frequently exhibits, when in solid form, both crystalline domains and amorphous domains interspersed. Prolonged or cyclic exposure to annealing temperatures develops increased crystallinity in a given sample of nylon 12.

With a view toward reusing SLS powder for extrusion, it might at first seem adequate to simply introduce pelletized forms of these used SLS powders into a pellet extruder (explained below) operating at a temperature exceeding the melting temperature for the given material types. In practice, however, these materials suffer problems with poor inter-layer adhesion and ‘runnability’ problems in extrusion processes.

Interlayer adhesion is particularly important for extrusion processes wherein one layer of build material is deposited and then generally experiences some cooling and solidification before a next layer is deposited over it. Compared to using SLS, objects constructed using extrusion deposition may exhibit anisotropic mechanical properties. In the direction of what may be termed a ‘build axis’, ‘vertical axis’ or, in Cartesian coordinates, a ‘Z’ axis, the tensile strength of a constructed object may be weaker than for the other two axes that lie along (or, for planar layers, are coplanar with) the longitudinal axis of the deposited beads. Whereas the lateral axis strengths are related to properties of continuous beads, Z-axis mechanical strength relies solely on fusion or reputation developing between surfaces brought into contact while at significantly different temperatures and during rapid cooling.

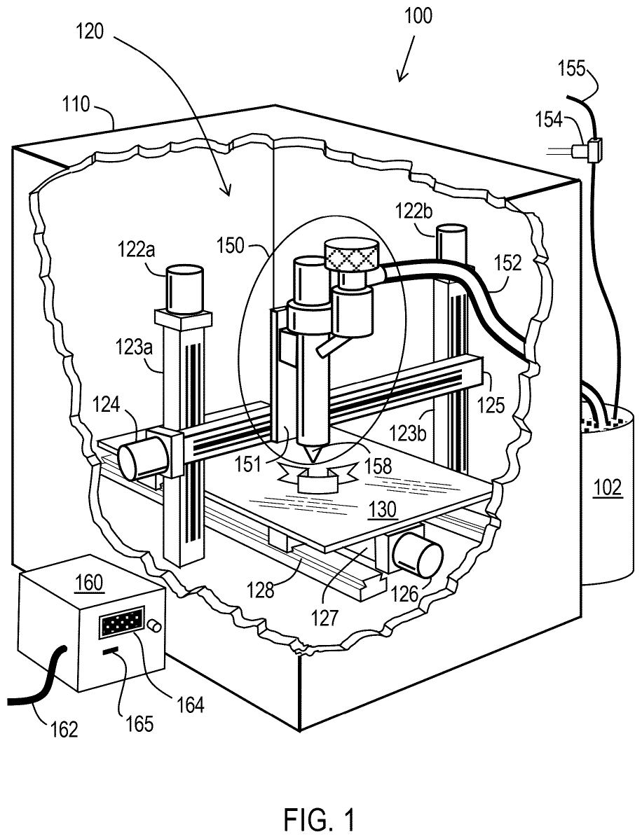

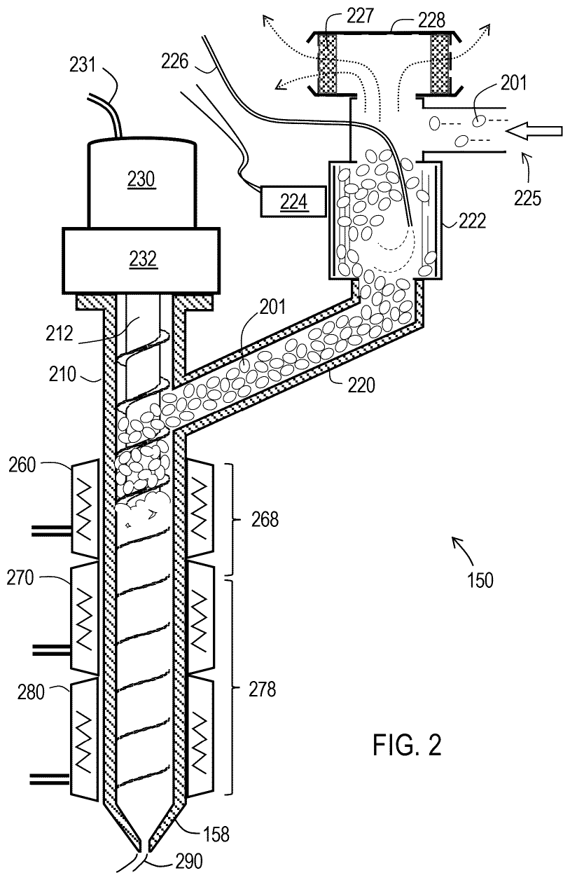

It has been observed that, when SLS powders are pelletized and fed into an extrusion deposition system (to be described in FIGS. 1 and 2), interlayer adhesion can be so poor that building a freeform part is not even possible. Extruded traces may fall waywardly or simply travel along with the nozzle rather than adhere at the intended deposit location. In other instances, extruded traces may appear to stack to some extent but then the part may be easily pried apart layer-by-layer. As one possible explanation for the poor interlayer adhesion, the SLS powders may comprise polymer chains that are tightly bound in crystalline structures and are unavailable to engage in molecular entanglement with those of adjacent build layers as successive layers of material are deposited atop one another.

These directly pelletized post-SLS materials also exhibit high resistance to flow through a pellet extruder and can cause excessive torque conditions in auger-driven extruder systems. (Because a similar extrusion process is also applied for forming filament from pellets for use in filament-fed extrusion deposition systems, difficulties in processing pellets are still relevant to non-pellet extrusion systems.) In some cases, the torque requirements are exceptional and may result in excessive wear or catastrophic failure of extruder components. Where an electric extruder drive motor is protected by an overcurrent sensing device, such as a circuit breaker, the protection may engage during a build or the machine operating speeds (feed rates) may have to be reduced to remain below the maximum torque cutoff. The build process may be unreasonably slow and burdensome in terms of both machine time and component wear. Under some circumstances, a circuit breaker or other current limiter may unexpectedly shut off the extruder during a large or prolonged build process, resulting in a scrapped part and wasted time and material. At the very least, fluctuating torque demands lead to unsteady discharge from the nozzle.

In accordance with example embodiments described herein, both the adhesion and rheological properties of a SLS-bound materials are dramatically altered by the addition of a small proportion of a chemically similar polymer species that exhibits a different or modified crystallization behavior, notably a crystallization-inhibiting behavior. One such species may comport with an ‘aperiodic polymer’ introduced earlier.

As a particular advantage, the teachings herein involve using one semi-crystalline species to render another similar polymer extrudable without resorting to actions such as adding foreign-species plasticizers, impact modifiers or creating graft copolymers. In preferred embodiments, both a first polymer with excessive crystallinity and a miscible second polymer used to mitigate that crystallinity feature the same functional groups, so that the chemical properties and compatibility are minimally altered by the combination. Ideally, a simple mechanical compounding process in melt form converts spent SLS material into a pelletized or filamentous form ready for extrusion applications. In some instances, the second polymer may even have been used as an alternative SLS feedstock. When both the first and second polymers come from post-SLS sources, the reclamation process serves a dual purpose.

The behavior of the preferred second polymer, and its action when combined with the first polymer, is explained by hydrogen bonding between polar functional groups on adjacent polymer chains. When a polymer chain having an aperiodic spacing of functional groups is produced, resulting in randomly varying numbers of methylene (—CH₂—) units between carbonyl-amine pairs in a polyamide chain, there is far less opportunity to form an optimal or strongly favored alignment for hydrogen bonds and less spontaneity in seeking such an optimum alignment. This lack of regular spacings among hydrogen bonding counterparts results in a polymer having generally lower crystallinity, lower energy change as crystallization occurs and considerable reluctance to reforming crystalline alignments of polymeric chains as the material cools from a molten, flowable or fusible condition.

For these reasons, an aperiodic polymer chain having these characteristics is regarded herein as one form of ‘inhibited crystallization polymer’ (ICP). Copolyamide 6/12 produced by random copolymerization involving a ring opening reaction of cyclic 6- and 12-carbon monomers is one example of a polymer having aperiodic or non-repeating spacings of functional groups. Note that this copolyamide, and others in this class, may be regarded as semi-crystalline though their crystallinity may develop over different temperature ranges and over prolonged timespans compared to counterpart species made from the same monomer lengths but in a regularly repeating pattern. Aside from this aperiodicity characteristic, some polymers may have sidechains and substituents that further interfere with the formation of highly regular crystalline domains and therefore contribute to lowering solidification temperature.

In the circumstances of the present disclosure, it has been observed that combining a spent SLS polymer with a small amount of an ICP improves interlayer adhesion and reduces extruder torque load for a given volume per unit time from an extruder nozzle. Without implying limitation to a specific principle of operation, it is conjectured that the significant reduction in extruder torque upon introduction of the polymer species having aperiodic functional groups energetically stabilizes the dissociation of the solidly crystalline domains of the SLS materials, which have regularly spaced functional groups and have undergone thorough annealing. Once the ICP polymer has become interposed among the more crystalline species and provided alternative hydrogen bonding pairings, the redevelopment of crystallinity is inhibited both in terms of spontaneity and in ultimately achievable crystallinity. Thus, the principal effect is thought to be a rheological change, although a lubrication effect may also be a contributing factor to the reduction in extruder torque. This rheological change, such as an effective reduction in viscosity, is critical for extrusion processes which deal with pressure and constricted melt flow conditions which are completely inapplicable in an SLS context.

It is contemplated that difficulty in extruding materials originally designed for SLS may be due to extensive crystallinity and resistance to attaining a more amorphous condition. It is further postulated that this effect may be exacerbated when only fillers alone are added which, aside from mechanical stiffening, may provide nucleation locations or templates for recrystallization.

It has been empirically observed that some ICP species, when used as the sole component in an extrusion deposition process, appear to behave in a somewhat gel-like manner and seem to retain some tensile strength, elasticity or radial integrity even when made sufficiently fluid to be discharged through a small nozzle opening. In attempts to form objects from an ICP species alone, difficulties are seen in that layered beads of the extruded material resist flattening and stacking as expected and, instead, slip laterally while maintaining the cylindrical shape imparted by the round nozzle opening.

Consequently, when a tall object has been constructed having at least one single-perimeter flat wall measuring roughly 30 cm horizontally by 30 cm vertically, the wall is seen to distort and bow significantly, laterally undulating or oscillating as the build proceeds vertically, with inward and outward excursions. Another form of distortion, generally referred to as ‘warping’ can occur as successive deposited layers cool and contract, causing an accumulation of internal stresses that causes a part to contort, even while still resting on the build plate.

When mixtures of various proportions of nylon 12 SLS powder plus an ICP species as described herein is used as an extruded material, the advantages of easier flow and a more cohesive, less brittle deposit are realized. However, these mixtures also tend to exhibit some residual distortions, warping or bowing of thin walls as observed for the ICP species alone.

In accordance with preferred embodiments of the present teachings, a more suitable compound for extrusion is prepared by further adding a filler, such as carbon fiber, to the above-mentioned mixture of spent nylon 12 and an ICP species. The ICP and the filler work in a complementary manner. In one possible explanation of this apparent synergy, the ICP, being miscible with the PA12, effectively solubilizes and plasticizes the latter, allowing for greater interlayer reputation to occur. Presumably counteracting the residual warping characteristics of the ICP species, the carbon fiber or other filler material acts to stiffen and strengthen the composite and may additionally interact with the polymer matrix components by mitigating volumetric shrinkage, by interfering with contraction of long ICP molecules that have been stretched or aligned by shear forces during extrusion or perhaps limiting or by impeding such stretching or unfolding of long molecules when the melt undergoes shear.

The end result of mixing the SLS powder, ICP and filler is a suitable extrusion feedstock that allows the spent SLS material to be converted into a desirable extrusion feedstock without chemically modifying the powder species or adding low molecular weight plasticizers, impact modifiers graft copolymers, solvents, or an inherently amorphous polymer species. This conversion is also accomplished without introducing any new functional groups that could alter the chemical or biological compatibility of the polyamide. The present teachings set forth, among other things, a novel utilization of a semi-crystalline polyamide to reduce crystallinity of another similar semi-crystalline polyamide species with further cooperation from a filler material that enhances the extrusion characteristics of the combination.

The addition of a small proportion of, for example, a nylon species having the same functional groups but with aperiodic spacings, that is, lacking a pattern that steadily repeats throughout the length of a polymer chain, provides for lowering the energy of separating chains having regularly spaced functional groups and stabilizing the less crystalline form. In practice, the addition of a small proportion of an inhibited crystallization polymer, featuring aperiodic functional group spacings, significantly reduces extruder torque and promotes steady flow in an extrusion-type additive manufacturing process. Furthermore, the application of ICP species to adapt the material for reuse is robust to variations from potentially inhomogeneous mixtures of SLS powders that have come from different sources, undergone various annealing temperature cycles and may be in various states of crystallinity. This sourcing as a byproduct from other processing creates challenges unlike the situation of formulating fresh polymer blends from virgin materials.

In gathering spent SLS powder from perhaps many sources, it is foreseen that indeterminate or uncontrolled proportions of PA12, PA11 and other polymers might be intermixed. As an advantage of the present teachings, the action of mismatched functional group spacings of an ICP is expected to have a similar effect when combined with either PA12 or PA11 or a mixture of both. Thus, successful compounding of these species with an ICP to render an extrudable composition may be relatively insensitive to the PA12/PA11 proportioning and the incidental mixing of these two post-SLS species may not need to be carefully avoided or regulated. It is conceivable that proportion of PA12, PA11 or other species in a re-processing batch could be estimated by weight or volume and that, if desired, an optimum proportion of an aperiodic second polymer might be adjusted accordingly based on a generalized rule.

Aside from the selective laser sintering process described above, solid objects may be formed by other additive processes. To afford a better understanding of a typical target environment in which the adapted feedstock material may be used and to explain how the material utilization contrasts with SLS and imposes different requirements, an extrusion-based additive manufacturing technique is summarized next.

Extrusion deposition manufacturing (EDM) is an additive process for building solid objects that involves melting a solid material, such as a thermoplastic, forcing the melt through a nozzle and depositing the molten material along a particular path onto the surface of a gradually enlarging workpiece formed from previous melt deposition which has already cooled and re-hardened. As plastic flows out of the nozzle, the motion of the nozzle relative to a starting substrate (or so-called ‘build plate’) is mechanically implemented using a motion control system comprising computer-controlled motors. By depositing extruded material, initially to a bare surface of the build plate and then to a workpiece that is progressively formed thereon, a finished object having specific dimensions and contours may be formed. Common materials used for EDM include ABS (acrylonitrile-butadiene-styrene), PLA (polylactic acid), terephthalate esters and nylon, but an increasingly wide array of plastics are being successfully ‘printed’ as the technology matures.

Recently applied to serve as moving 3D printing heads, direct pellet extruders offer many advantages over the types of extruders that accept fixed-diameter solid filament from a spool. As a principal advantage in industrial printing, a pellet extruder can handle long, uninterrupted builds that would otherwise consume multiple conventional-size spools when using a filament extruder. For example, using a pellet extruder, a large 3D printed object with a mass of 100 Kg can be formed over a period of hours or days of continuous printing. In contrast, a filament-type extruder building the same object would require numerous interruptions for changing spools, which are commonly supplied in 1 Kg, 10 Kg or 25 Kg sizes. At each point during the build when an empty spool of material must be replaced, there is a risk of affecting the quality of the object and, in some cases, the interruption may even jeopardize an entire print process in which hours of print time and considerable expense have already been invested.

FIG. 1 depicts an industrial extrusion deposition manufacturing (EDM) system 100 operating within an optionally heated enclosure 110. System 100 is shown to comprise a motor driven multi-axis motion control system 120 which controllably moves extruder head 150 relative to build plate 130. The motion control componentry combined with extruder head 150 constitute a fused deposition modeling system, or what is often referred to as a ‘3D printer.’ Multi-axis motion control system 120 as shown creates movement along three orthogonal axes in an arrangement known as a Cartesian coordinate system wherein any point within the build space is referenced by a unique triplet of scalar values corresponding to displacement along three mutually orthogonal axes. To provide some sense of scale, system 100 may encompass a build volume of 1 meter wide by 1 meter deep by 2 meters tall, for example.

Extruder head 150 is shown to be attached to carriage 151 that is controllably moved along the long axis of transverse beam 125 by the rotation of the shaft of an X-axis motor 124 acting upon a lead screw or taut belt (not shown) inside transverse beam 125. To raise or lower transverse beam 125 (along with extruder head 150) relative to build plate 130, Z-axis motors 122a, 122b similarly act upon lead screws or belts within columns 123a, 123b. To accomplish yet another relative motion between build plate 130 and extrusion head 150, a third motor, which may be referred to as Y-axis motor 126 may act upon a leadscrew 127 to which the build plate 130 is coupled. The rotation of the shaft of motor 126 controls the position of build plate 130. Build plate 130 may be supported by, and may slide or roll along, linear bearing rails such as rail 128. Motors 122a, 122b, 124 and 126 are often stepping motors in small, inexpensive implementations but may also be servo motors equipped with a shaft position encoder and/or tachometer operating in a closed-loop control mode to facilitate moving to very precise positions. Many such arrangements of motors, augers, bearings and associated components are possible.

It should be understood that the arrangement of motors, bearings and such depicted in FIG. 1 is merely one example for achieving controlled relative motion between extruder head 150 and build plate 130 so that an object is formed by the extrusion of materials through nozzle 158. Various other arrangements are common and equally suitable as an embodiment in which an extruder may be suspended over a build plate and moved about in a controlled fashion. The present invention is equally applicable to a wide variety of motion control arrangements, including those just mentioned as well as so-called ‘Core XY’, ‘H-bot’ and ‘delta’ arrangements.

In addition, it should be understood that, for simplicity, FIG. 1 excludes many fasteners, brackets, cables, cable guides, sensors and myriad other components that may be employed in the manufacture of such systems but which are not essential for explaining the principles of the present invention nor for describing the best mode thereof. Where linear guides and lead screws have been described, the present invention should not be construed as being limited to application in machines that use such mechanisms and that, for example, belt driven systems and gear driven systems are equally suitable for use and equally susceptible to the challenges that the present invention addresses.

Extrusion head 150 will be described in further detail in FIG. 2. In summary, the role of extrusion head 150 is to receive plastic in pellet form driven by bursts of air through a feed tube 152 and to melt the plastic and drive it out of the end of nozzle 158 in a continuous stream. Typically, plastic pellets are stored in a large external pellet reservoir 102 and provided to extruder head 150 in small increments as needed. A detector (sensor 224, described below) included with extruder head 150 determines when additional pellets are needed and electrically controls the actuation of an air valve 154 which switches on a momentary burst of compressed air as provided by compressed air inlet 155 to propel pellets toward extruder head 150.

To accomplish the formation of a solid object in three dimensions upon the build plate 130 from extruded materials emanating from the tip of nozzle 158, a control box 160 is provided with electronics, such as a microprocessor and motor drive circuitry, which is coupled to the X, Y and Z motors as has been described above, as well as to numerous sensors and heating elements, in the system 120, some of which will be described further below in connection with FIG. 2. Electronics within control box 160 also control an extruder motor, to be described below.

A wide variety of commercially available 3D printer control boards may be used. The primary role of such controller boards is to interpret sequential lists of positional commands, such as so-called G-code files and to output signals that drive the motors to implement the commanded movements. A G-code file, or the like, describing the coordinate movements necessary to form a particular object may be supplied to the controller through connection of the controller to a wired data communications network via, for example, TCP/IP communications through an Ethernet connection or via a wireless network connection, such as ‘WiFi’ or IEEE 802.11 connection. A G-code file (or a data file, such as a file in STL format from which a G-code file may be prepared) may also be supplied on a removable flash memory card, such as an SD card, which may be inserted at SD card slot 165 on control box 160. Control box 160 may receive input signals from sensors associated with various parts of system 100 and carry out logical functions based on the inputs. In particular, electronic circuitry or programmed logic executing on processor within control box 160 may receive sensor signals related to the amount of torque being applied by a motor to turn an auger within pellet-type extruder head 150. As will be explained below, this measurement will reflect rheological attributes of the material being extruded.

For providing a human-accessible control interface, essentially all of the available control boards support an LCD display and user interface 164, as is shown to be a part of control box 160 in FIG. 1. The electrical power to drive the control box 160 and the motors, sensors and heating elements of system 120 comes from a connection to electrical power lines 162.

FIG. 2 provides a more detailed view of the working of extruder head 150. As introduced above, the role of pellet-type extruder head 150 is to convert solid pellets of plastic into a controlled stream of molten plastic and to deposit the plastic at specific locations to form an object on build plate. In FIG. 2, extruder head 150 is shown to comprise auger 212 disposed inside of a roughly cylindrical barrel 210 which may be tapered to complement the shape of lands or flutes on the auger. Rotation of auger 212 by the action of a motor 230, acting through reduction gearbox 232 to achieve high torque at low speed, causes a generally downward movement of plastic pellets 201 entering the barrel from pellet hopper 220. Power or drive signals are supplied to motor 230 through electrical conductors, shown as wires 231.

Barrel 210 is heated by a plurality of thermostatically controlled heating stages 260, 270 and 280 which are controlled to achieve a desired temperature profile along the length of the barrel. For example, as pelletized materials enter at the top of the barrel and are compressed and compelled down by the auger, it is desirable for an upper zone referred to as a ‘transition zone’ 268 to be set at a temperature somewhat lower than the ultimate nozzle discharge temperature. Further down barrel 210, the materials may experience a temperature nearing the final melt temperature as they pass through a melt zone 278. Highly crystalline pellets of material may resist softening and require greater torque on the auger to sustain a given discharge rate.

The effects of the heat thus applied to barrel 210, along with the compaction and propulsion of material through the barrel by auger 212, are apparent in that loose pellets 201, which are depicted as loosely arranged and which tend to settle downward under gravity within pellet hopper 220, are contacted and driven downward by auger 212. As the pellets are driven downward and enter transition zone 268, the pellets begin to soften and flow into one another and any interstitial air starts to be driven out due to the rising pressure. As the softened materials move into the more elevated temperature of melt zone 268, the melted plastic becomes homogeneous and free of any voids or air bubbles. In moving downward through the barrel, the materials reach full temperature and are driven down into nozzle 158 and they can be ejected as a continuous bead in the form of an extruded output 290. Control of extruder motor 230 in coordination with the motion effected by the motors 122, 124, 126, results in controlled amounts of material being deposited in specific locations and patterns to construct a three-dimensional solid object of specified shape on build plate 130. Fluctuations in torque load may translate to unsteady discharge even when programmed motion calls for constant flow.

Pellets 201 are provided to extruder head 150 from a remote location at pellet inlet 225. As mentioned previously, a long pellet feed tube 152 may deliver air-borne pellets using blasts of compressed air. As a burst of air carries pellets into the extruder head 150, the pellets fall into a holding chamber 222 and the air that carried the pellets disperses upward through an air filter 228 which comprises a fine screen or filter medium 227 to retain conveyed pellets while allowing air to escape.

As pellets within feed hopper 220 are consumed by the extrusion process, a pellet level sensor, such as capacitive sensor 224 attached to holding chamber 222, signals when another blast of air via air valve 154 is needed to bring more pellets into extruder 150. For reliable feeding of pellets into pellet hopper 220, a stream of compressed air may be supplied through tube 226 to provide constant agitation of pellets inside holding chamber 222.

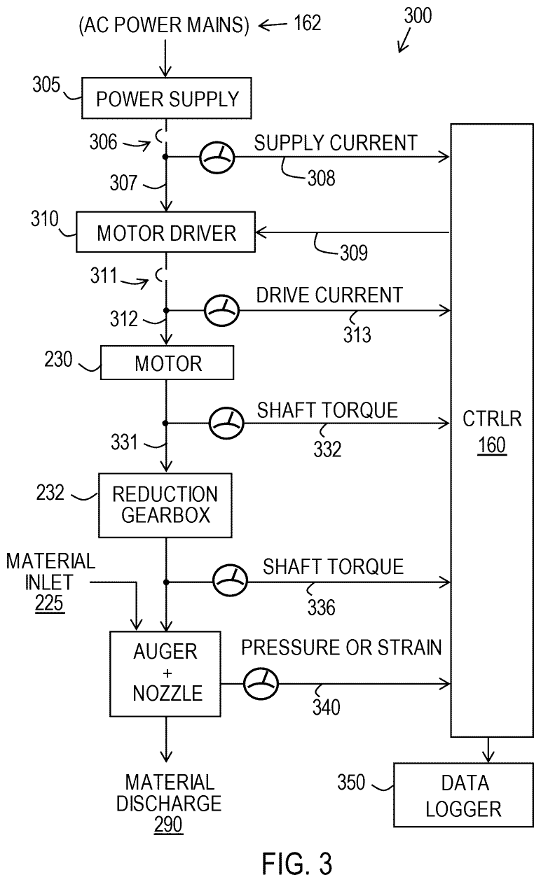

FIG. 3 is a block diagram 300 of a typical drivetrain for a pellet extruder of the type shown in FIG. 2, along with points at which extruder torque may be measured directly or indirectly and provided as data to a controller 160. In block diagram 300, several different means of monitoring extruder torque are presented, any of which may be used singly as alternatives to one another, or may be used in any combination.

At the top of FIG. 3, a power supply 305 is shown to receive power from a main supply 162 and to convert the mains supply, which is generally alternating current (AC), into a direct current (DC) suitable for driving or supplying electrical power to other components of the system, including controller 160. Power supply 305 conducts electrical power to motor driver 310 through an electrical conduit 307, which may comprise heavy gage insulated wires. In series with electrical conduit 307, a circuit breaker 306 is shown which provides overcurrent protection if either the motor driver 310 begins to draw too much current, or if some other electrical fault, such as a short circuit along electrical conduit 307 occurs. Circuit breaker 306 is designed to prevent fire, sparks or damage to electrical components under such fault conditions. A means for monitoring the amount of current flowing through electrical conduit 307 is represented as supply current monitoring tap 308, which provides an indication of current levels to controller 160. The current through electrical conduit 307 may be monitored by a low-resistance shunt in series with the circuit that will develop a voltage drop across the shunt as a function of the current levels. Current monitoring tap 308 may also be implemented using an analog-to-digital converter or the like to render a digital representation of the current level.

Motor driver 310 is shown to be electrically coupled to motor 230 through electrical conduit 312 which may comprise a plurality of electrical conductors such as insulated wires. A circuit breaker 311 (or a multi-pole breaker group) is also shown connected in series with electrical conduit 312 and, like circuit breaker 306, serves as a failsafe mechanism for opening the electrical circuit in the event that either motor 230 draws too much current or some other electrical fault occurs along conduit 312 that constitutes an excessive load. Current through conduit 312 may be monitored by a monitoring tap 313, which may involve a low resistance current shunt and an analog-to-digital converter (or simple thresholding circuit) that provides information to controller 160 indicative of the voltage drop across the shunt and, therefore, the current through electrical conduit 312. Motor driver 310 provides comparatively high-power signals that control the position of motor 230. For example, if motor 230 is a stepping motor, then motor driver 310 acts to receive positional commands from controller 160 through motor interface 309 and produce the correct voltage or current levels on specific conductors within electrical conduit 312 that achieve the desired positioning or speed of rotation of the motor 230. In typical use, within a pellet extrusion environment, command signals will be sent from controller 160 along connection 309 to motor driver 310 at comparatively low signal levels whereas motor driver 310 will act as a current amplifier to supply the necessary currents to motor 232 to carry out the commands received over command line 309. As a build process proceeds using a pellet extruder, command line 309 will often comprise more or less steady pulses or numerical information that cause motor 232 continue to rotate its shaft primarily in one direction that results in progressive discharge of material such as out of nozzle 158 shown in FIG. 2.

Whereas the power transmitting linkages so far have been electrical conduits 307 and 312, the linkage between motor through 230 and reduction gearbox 232 is a mechanically coupled rotating shaft 331. In use, motor 230 rotates its shaft 331 in response to command signals over command line 309 which drives the input shaft of reduction gearbox 232 and converts a moderate torque at a given speed along shaft 331 into a higher torque and comparatively low speed transmitted through shaft 335. For both shafts 331 and 335, it is possible to implement a torque measuring or torque reporting device, such as a rotating strain gage, or to gage the force being applied to the motor mounts of motor 230, reduction gearbox 232, or of other attachment or mounting members between reduction gearbox 232 and other parts of the pellet extruder structure. Because these forces will be passed along through the housings of the motor or reduction gearbox, shaft torque can be inferred from the forces sensed at these other anchoring points. Representative of all of these possibilities for measuring mechanical torque on a shaft, monitoring taps 332 and 336 are shown as being able to take torque readings from either shaft and provide that data to controller 160.

At this point, FIG. 3 has presented at least two alternative electrical methods for monitoring the torque being applied to auger 212 and two directly mechanical means for measuring the torque as well. As yet another means for determining the torque that is having to be applied to auger 212 to achieve material discharge 290, a pressure or strain gauge 340 is shown as a potential monitor which may act by sensing deformation of nozzle 158 or other components under the pressures of the melt being applied by auger 212. This latter means of monitoring the activity of auger 212 are thought to be perhaps less specifically limited to only indicating auger torque but are also a function of other conditions of flow and other characteristics. Nevertheless, as rheological properties are to be measured, including melt viscosity, the data from monitoring point 340 may be useful to report to controller 160 as an indication of the melt viscosity. It should be noted for this choice of monitoring, however, that were the auger to be stalled by friction or other impediments further up the extruder barrel, the pressure or strain of the nozzle could appear to be minimal while the extruder motor might actually be extremely burdened. FIG. 3 also shows a data logger 350 which may be a device for recording readings of extruder torque as a function of time. Controller 160 may send to a data logging entity or controller 160 may host a data logger functionality within its executing software instructions.

In an actual reduction of practice, one of the electrically-sensed arrangements depicted in FIG. 3 was utilized to assess the effects of various nylon mixtures on extruder torque.

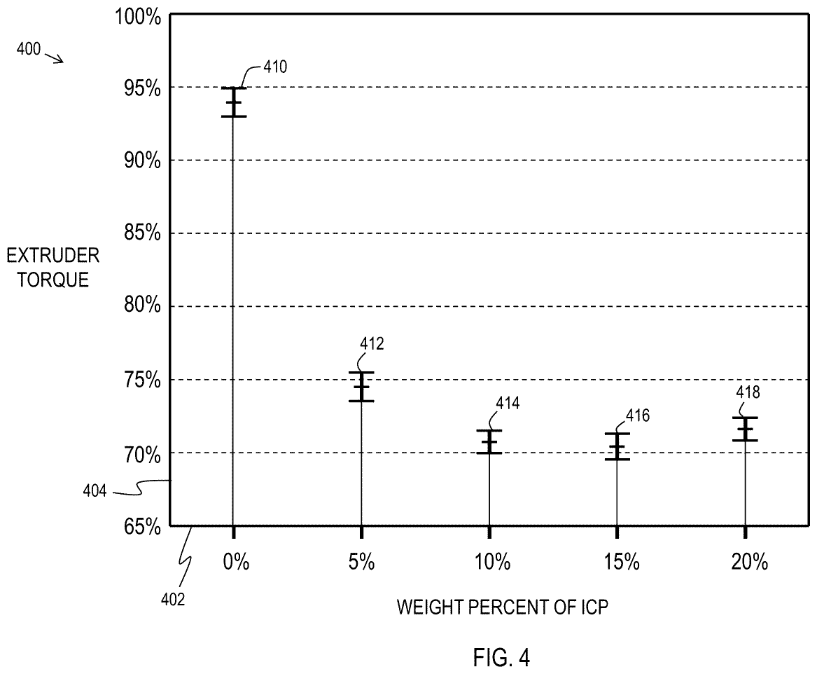

FIG. 4 provides a plot 400 of relative extruder torque in (along vertical axis 404) as a function of weight percent (along horizontal axis 402) of post-SLS nylon mixtures in accordance with a preferred embodiment of the present teachings. This data was produced by using a variation of the apparatus in diagram 300, specifically one in which the motor driver output current to motor 230 was tapped as in monitoring tap 313, reported to controller 160 and logged using a data logger integral to controller 160. In plot 400, five different values of average extruder torque were monitored as a pellet extruder was extruding approximately 800 cubic millimeters of melt per second at approximately 225° C. through a 1 mm nozzle.

Vertical axis 404 represents a range of 65% to 100% of the nominal maximum rated torque for the auger assembly that was being used at the time. The 100% level represents a maximum continuous torque rating and at some point beyond this torque level a protective mechanism, such as circuit breaker 306, circuit breaker 311 or logic within controller 160 could intervene by discontinuing drive current to motor 230. Each of data points 410 through 418 in plot 400 are presented with a short horizontal bar representing the average of the readings and then broader upper and lower bars representing the limits that encompass a 99% confidence interval based on the 200 data points that were recorded while each particular mixture was being extruded.

First data point 410 was sampled while a spent SLS polymer in pellet form was provided to the test pellet extruder without any ICP polymer having been added. In this case, the average torque (N=200) is approximately 94% and the confidence interval limits demonstrate a fairly narrow range within which subsequent samples would naturally fall if the subsequent additions of ICP polymer were to have no discernible effect. Data point 412, representing a composition including 5% weight percent of ICP polymer, shows an average torque of around 74.5%, again exhibiting a fairly narrow set of limits (p≤0.01). Data point 412 represents a marked change from data point 410. Subsequent data points 414, 416 and 418, each with a higher weight percent of ICP polymer, show that a better than 20% reduction in extruder drive torque is achieved when a 10% or greater weight percent of ICP polymer is mixed in with the expended SLS polymer species. From plot 400, it is apparent that a relatively small weight percentage of ICP added to spent (and presumably highly crystalline) SLS polymer achieves a dramatic reduction in extruder torque. This is significant because the mixture of previously used SLS powder along with some version of ICP polymer creates an extrudable composition that is less likely to exceed extruder torque limit settings and enables faster throughput by improving one or more rheological properties of the mixture. From plot 400, it is evident that introducing even 2.5% or 5% of an ICP species considerably relieves extruder torque and in some instances these concentrations may be adequate to yield an extrudable compound for a given application, extruding system or deposited part.

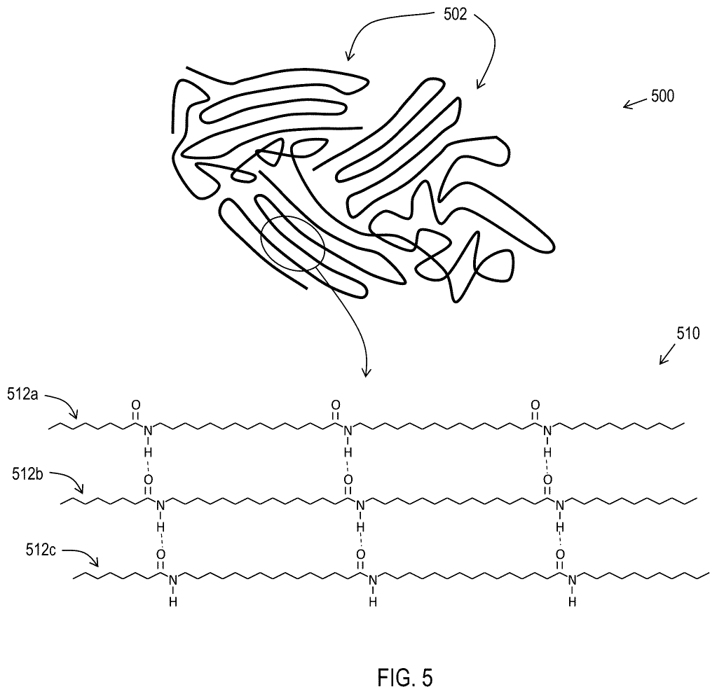

To explain this phenomenon, FIG. 5 depicts what is believed to be the prevailing crystallization pattern in a typical nylon 12 polyamide, as is likely to exist in a discarded SLS powder that has undergone many cycles and prolonged periods of annealing conditions. In FIG. 5, pictorial 500 shows the presence of a few crystalline domains 502 which have visually noticeable alignment, coalescence or lamellar character. A portion of one crystalline domain is portrayed in an inset diagram 510 of molecular chains showing how, when the polymer chains of nylon 12 come into parallel alignment, a very regular pattern of hydrogen bonding is established between the carbonyl groups of one chain and the amine hydrogen atoms on an adjacent chain. Notably, this creates a comparatively rigid structure and this crystallinity forms readily and makes for an energetically favorable arrangement of the parallel polymer chains 511a, 511b and 511c.

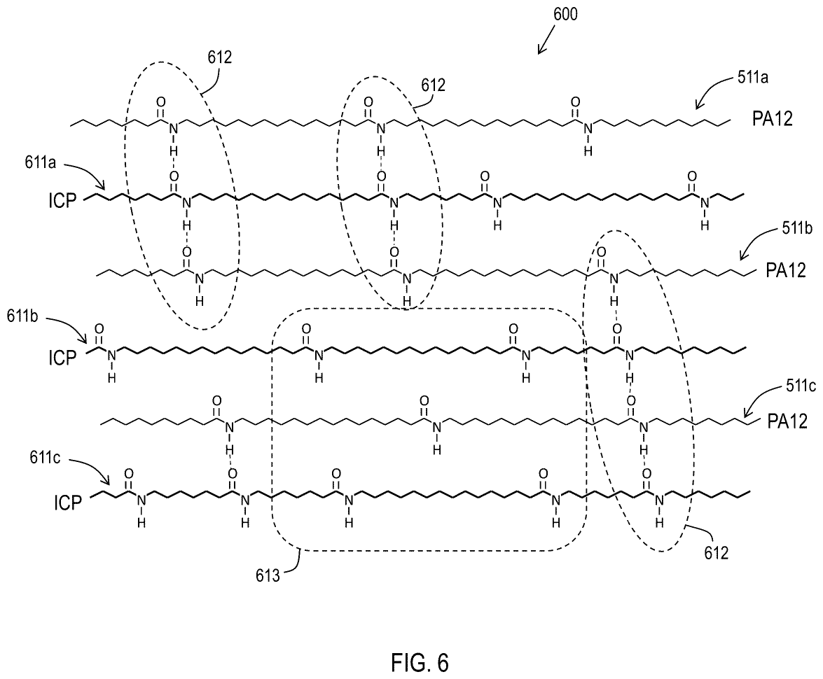

In contrast, FIG. 6 shows a hypothetical situation in which three chains of an inhibited crystallization polymer (ICP), one with aperiodic or non-repeating functional group spacings, have come between chains 511a, 511b, 511c and have, in a sense, satisfied the hydrogen bonding tendencies of at least some of the functional groups on the nylon 12 chains while at the same time greatly reducing the rigidity of the structure that was evident in drawing 510. (While FIG. 6 happens to portray a 1:1 ratio of nylon 12 and ICP species for illustrative purposes, this should not imply that the present teachings are predicated upon or limited to combining these polymers in equal parts.)

Chains of nylon 12 comprise amide functional groups spaced at regular intervals with 12 methylene units between each. Other common types of nylon may comprise an alternating pattern of 6-12-6-12-6-12 . . . etc. methylene groups between amide functional groups. Either case exhibits a consistent pattern of functional group spacing that repeats for the entire length of the macromolecule. In other words, for each of these examples, it is possible to identify a repeating unit of a short segment of the chain that completely characterizes the incidence of amide functional groups along the entire chain. On the other hand, for a type of ICP that is a polyamide but with randomized spacings between functional groups, there is no predictable or discernable repeating pattern that can summarize the occurrence of amide functional groups along the entire length of the chain. For example, the number of methylene groups between amide groups observed on a short portion of a given ICP molecule might be ‘ . . . 12-6-6-6-12-6-12-12-6-12-6-12-12-12-12-6-12-6-6-6-12-6-6-12-12-12 . . . ’ and this particular sequence might not be present at any other part of the molecule. The difference between regular spacings on some molecules and irregular spacings on other molecules has a significant effect on material properties when the two types of molecules are mixed together, as explained in FIG. 6.

Some functional groups that are located on polymer chains 611a, 611b and 611c align with counterparts on the nylon 12 chains (see outlined regions 612), but there are also regions, such as outlined region 613, where some functional groups on both types of chains are mismatched unless they connect three-dimensionally to other chains that are out of the plane of this sketch or if they become bunched together or looped back on themselves. Regardless, FIG. 6 shows a far less regular arrangement of hydrogen bonding pairings compared to those that were shown in diagram 510. In terms of mechanical properties, the introduction of the ICP polymer chains 611a, 611b, 611c are shown to disrupt the regularity of hydrogen bonding patterns resulting in a less rigid polymer structure and one for which viscosity or other rheological properties may shift considerably in the polymer subjected to temperatures above its glass transition temperature and above its melt temperature. (It is acknowledged that the short portions of ICP polymer chains 611a, 611b, 611c shown may actually be different parts along a single ICP polymer chain.)

Thus, the ICP polymer chains that were introduced as shown in FIG. 6 appear to perform a function similar to a plasticizer, significantly changing rheometric properties such as melt flow viscosity.

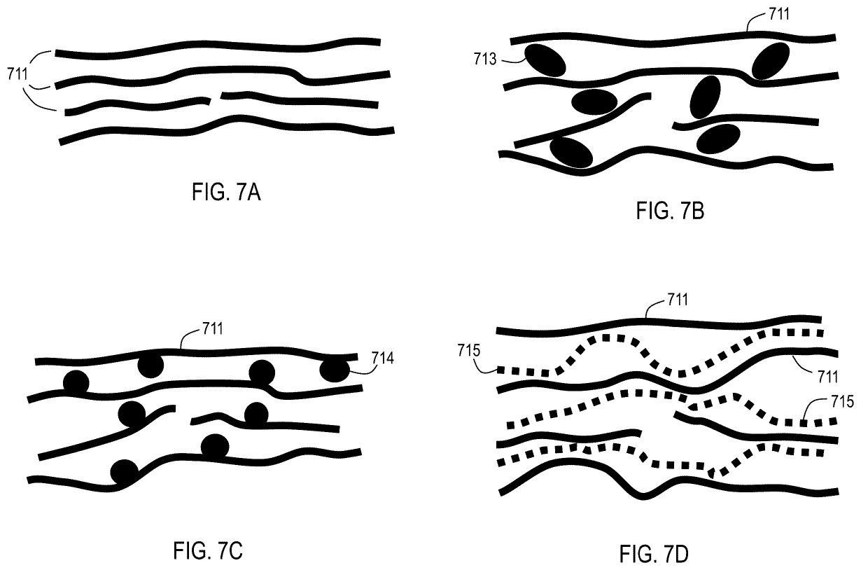

To further elaborate on the practical value of this characteristic, FIG. 7 provides a conceptual view of molecular conditions using various type of plasticizers. For reference, FIG. 7A shows a regular, close stacking of nylon 12 polymer chains 711, the configuration of which is energetically favorable due to the hydrogen bonding that goes on among polar functional groups, especially when they occur at equal, regular intervals on adjacent polymer chains.

FIG. 7B shows an arrangement in accordance with one typical practice in the field of creating plasticizers for polymers. In this case, classes of relatively small molecules 713, such as phthalates, adipates, citrates or trimellitates, are miscible with, or have some affinity for, a major polymer component to be plasticized, such as nylon 12 or polyvinyl chloride (PVC). When mixed into the matrix of longer chains, however, the smaller molecules interfere with close coupling of the larger molecular chains. An important disadvantage of using such small molecules as plasticizers is that the plasticizing molecules can leach out of the plastic matrix when exposed to heat or solvents. This effect can cause localized embrittlement in mechanical and plumbing applications. This same phenomenon also raises concerns over the use of plasticizers in food and beverage containers because the plasticizers can migrate out of the plastic matrix and into the food and beverage contents. Another drawback to using small molecule plasticizers is that they often have a different chemical behavior than the main polymer species that they are supposed to plasticize. Their chemical reactivity or compatibility with solvents, reactive chemicals or ultraviolet light may be different so that the act of plasticizing the main plastic alters its suitability for intended applications compared to the pure polymer.

FIG. 7C depicts yet another technique for plasticizing in which the main molecular polymer chain 711 is chemically modified with substituents 714 that inhibit or interfere with hydrogen bonding. For example, aromatic side groups may be introduced which are bulky and prevent close alignment and crystallization among proximal molecular chains. In application to the challenge of adapting recycled or spent SLS powders for use as extrudable materials for extrusion additive manufacturing, chemically modifying the polymer powders is a burdensome and likely cost-prohibitive avenue. Furthermore, if such a plasticizing method were used in that context, such modifications would alter chemical or mechanical characteristics of the main polymer chain.

In contrast to these techniques, FIG. 7D represents a novel approach to plasticizing or otherwise effecting a rheological change in a polymer material in accordance with a preferred embodiment of the present teachings. FIG. 7D represents the situation wherein a given polymer species to be plasticized (polymer chain 711) is combined with an ICP polymer (polymer chain 715, represented as a dashed line) having the same functional groups and roughly the same average molecular weight as the major species but lacking a regular pattern to the occurrence of functional groups along the chain. This combination achieves a plasticizing effect or rheological change as was described in conjunction with FIG. 6 and yet does not significantly change the chemical nature of the polymer. Of practical significance, the change in rheological characteristics can render a spent SLS material easier to repurpose as an extrusion-type additive manufacturing feedstock and can do so without changing the fundamental chemistry of the functional groups and without adding small, foreign molecules that are susceptible to migration or leaching. It is also noted that the proportion of the ICP needed to be added to achieve the desired rheological change is relatively low and yet a process in accordance with the present teachings is also insensitive to any over-proportioning of the ICP into the mix. The chemical properties are believed to be preserved even to the point that a plasticized mixture may exhibit the same biocompatibility characteristic as the native or main polymer component alone.

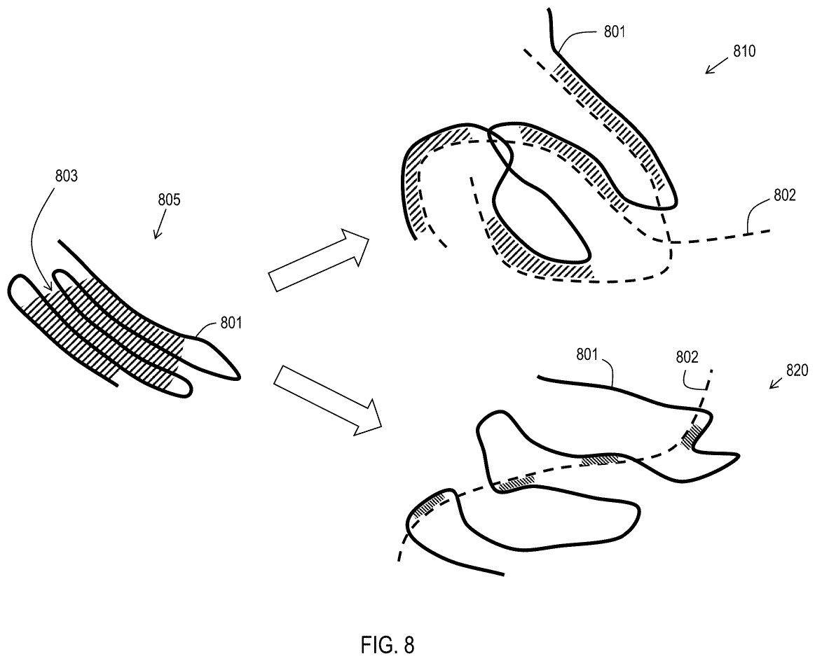

Turning now to FIG. 8 and elaborating somewhat on the effects explained in FIG. 6 and in FIG. 7D, FIG. 8 portrays how the introduction of an ICP polymer may stabilize the dissolution or the disbanding of crystalline domains as may exist in a spent SLS polymer. A first view 805 shows a regular arrangement of closely aligned portions of a folded nylon 12 molecule 801 or, equivalently, among several molecules of nylon 12 in sufficiently close proximity for mutual hydrogen bonding to occur. Throughout FIG. 8, the attractive force caused by hydrogen bonding is depicted as a crosshatched region 803 indicating the tendency for molecular chains to stay aligned. Upon introduction of an ICP polymer in view 810, the nylon 12 chain has abandoned its intramolecular bonds and engaged in forming replacement hydrogen bonds with ICP molecule 802, which is also a polyamide but, unlike the nylon 12, exhibits irregular spacings between functional groups. This occurs in enough locations to allow the formation of a more amorphous yet stable form as shown in view 810. An ICP molecule need not fully align with and participate in a net one-to-one ratio of functional group bonds with a nylon 12 molecule. In view 810, a single nylon 12 molecule is shown to be partially engaged by more than one ICP polymer molecule. Conversely, a single ICP polymer molecule may participate in stabilizing the unstacking and forming of alternative hydrogen bond pairings along more than one nylon 12 molecule.

Once this rearranging of hydrogen bond pairings has occurred at elevated temperatures then, upon subsequent cooling, a return to the crystalline configuration of view 805 is unlikely even though it may be somewhat more energetically favorable. As long as the ICP polymer is present and has established the replacement hydrogen bonding shown in view 810, it is unlikely that the nylon 12 would spontaneously displace the ICP polymer molecules in an orderly fashion and return to the structure shown in view 805. Accordingly, the rheological change caused by the introduction of the ICP is thought to be permanent for as long as the component molecules remained intermingled. The presence of ICP nylon species both spatially impedes recrystallization of the nylon 12 and energetically diminishes the incentive for recrystallization to occur.

As a similar mechanism by which an ICP molecule might stabilize a more disorderly arrangement than shown in view 805, view 820 depicts how an ICP molecule 802 may cross a nylon 12 chain laterally in several places and interact over several localized points to hydrogen bond with the original nylon 12 molecule 801 and perhaps with other hydrogen bonding sites on other nylon 12 molecules that are scattered in three dimensions but not shown here. The presence of the ICP chain crossing the nylon 12 chain resists the tendency to coalesce back into the configuration shown in view 805. It is likely that a variety of effects similar to those depicted in views 810 and 820 all happen simultaneously to some extent in three dimensions. In the context of additive manufacturing by depositing layer upon layer of heated material, the more scattered and amorphous chains shown in the latter views may provide better entanglement or ‘reptation’ among molecules where adjoining deposited layers meet, therefore improving mechanical strength of the constructed object in a direction in which the build progresses, often referred to as ‘Z-axis strength’ though not all extrusion deposition process involve strictly planar layers.

In light of the present teachings, it is considered that other typical nylon species, such as nylon 6, ‘nylon 6,12’ or the like, might also be combined with spent SLS powder but, because of their regular repeating pattern of functional groups along the entire length of the their molecular chains, these alternative additives would simply participate in recrystallizing and causing a restoral of the arrangement shown in view 805 and would not be as effective in plasticizing nylon 12 polymer chains. Referring back to FIG. 6, the disruption of the regularity of hydrogen bonding patterns was due to the randomization of the occurrence of 6-carbon spacings and 12-carbon spacings between functional groups. Were the intervening molecules 611a, 611b, 611c to have regularly spaced functional groups or repeating patterns of functional groups, the disruption of the pattern of very regular hydrogen bonds that are portrayed in FIG. 5 would not take place.

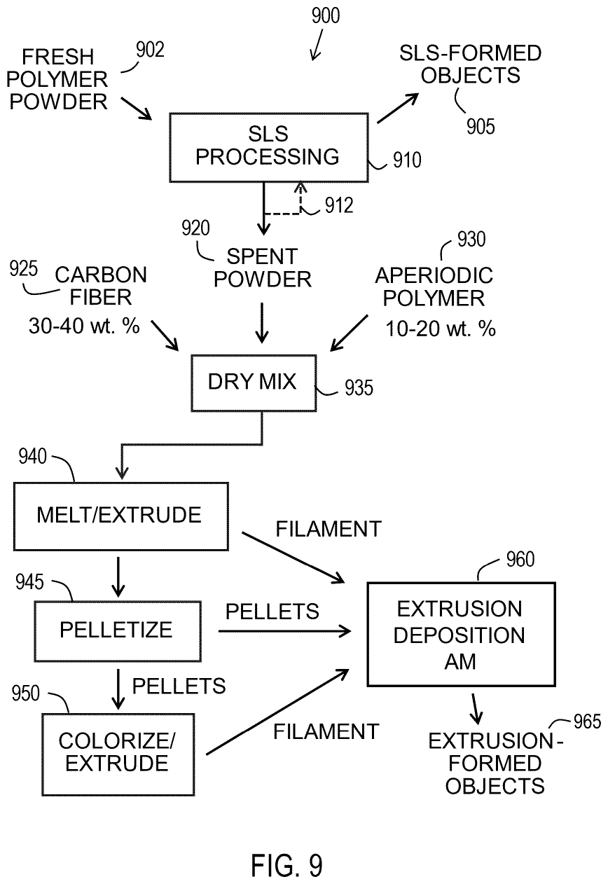

FIG. 9 depicts a general process 900 for reclaiming and repurposing spent SLS powder in accordance with illustrative embodiments of the present teachings. One or more instances of existing SLS processes 910 are shown to accept a supply of fresh polymer powder 902 and to yield products formed from the powder, represented as SLS-formed objects 905. As explained earlier, each cycle of an SLS process also produces a volume of powder that was not irradiated to become a formed part but nonetheless has undergone prolonged temperature exposure. While some recycling of such powder is normally practiced (as shown by return arrow 912) all unincorporated loose powder eventually becomes unsuitable for SLS and is set aside as a byproduct, spent powder 920. The diagram elements explained thus far are typical of traditional SLS processing.

In accordance with a preferred embodiment, spent powder 920 is combined with a second polymer 930 that is preferably of a species that is miscible with spent powder 920. In particular, second polymer 930 is preferably chemically similar to spent powder by virtue of, for example, having the same functional groups as the spent powder. In one possible embodiment, spent powder 920 and second polymer 930 may both be polyamides. In a more preferred embodiment, spent powder 920 may comprise a regular repeat polymer species and second polymer 930 may be an aperiodic polymer species.

Second polymer 930 may be introduced as new material that has never undergone previous processing towards making a part or, alternatively, as a byproduct of an SLS process that has used the aperiodic polymer as a principal build material or as a mixture of both new and used material. Carbon fiber 925, spent powder 920 and second polymer 930 are preferably combined, either in batches or in a stream, such that the final composition comprises about 10% to 20% by weight of the second polymer and about 30% to 40% by weight of the carbon filler, with the majority of the remaining percentage being the spent powder species. Considering that some benefits in torque reduction can be realized with as little as 2.5% or 5% addition of a second polymer (refer to plot 400), many ranges of useful proportions of the second polymer are possible and some heavier proportions may be particularly beneficial if the second polymer is also to be reclaimed from previous manufacturing use. Some ranges for the proportion, by weight, of the second polymer in the final composition include, but are not limited to, 2.5-5%, 5-10%, 10-15%, 15-15%, 25-50%, 5-15%, 10-20% and 12-18%. In any combinations with these ranges that will not exclude spent powder 920 in the final composition, the proportion of filler, such as carbon filaments, may be within one or more of the example ranges including 10-50%, 10-20%, 10-25%, 15-35%, 10-35%, 25-35%, 25-45%, 30-40% and 32-38%. Again, depending upon part applications, specific extrusion systems or qualities of spent powder 902 and second polymer 930 as input materials, different proportioning of filler, such as carbon, graphene, glass, quartz, natural or synthetic fibers, mineral or plant fibers, may be appropriate.

Other optional additives, colorants, protectants, fillers or modifiers may be added in lesser amounts but are neither required nor strictly precluded by the present teachings. These components are recommended to be first blended in dry form, generally in the form of fine particles as indicated by dry mix process 935.

Once the ingredients are sufficiently intermixed and homogeneous, the material is supplied to a heated extrusion process 940 that melts and thoroughly churns the composite material, discharging it as a molten stream. In some implementations, it may be possible to discharge the melt through a nozzle or die of a specific size yielding a continuous filament suitable to supply an extrusion deposition additive manufacturing system. More commonly, however, the output of extrusion process 940 is a larger rod of composite that is immediately cooled and then chopped into pellets of uniform size. (See pelletizing process 945.) The resulting pellets may be used as feedstock in pellet-fed extruder as shown in FIGS. 1 and 2 and may be formed into additively manufactured articles. Another likely disposition for the pelletized composite from process 945 is to be supplied in pellet form to a manufacturer of 3D printer filament. As indicated by process block 950, the pellets may be combined with colorants and once again melted and discharged through a nozzle. The nozzle exit size will generally produce a filament of standard diameter and the discharge will be cooled and spooled as end user consumable units. Quite often, a supplier of standard sized spooled filaments for smaller 3D printers will be geographically remote from a supplier of pelletized raw materials and will also need to agilely produce various colors in comparatively small runs to meet fluctuating consumer demands. Although the composite material is to end up as a continuous filament, the pelletized intermediate form is convenient for transport, storage, drying and metering into smaller batches. Either in filament or pellet form, the composite material prepared as shown is subsequently used by one or more extrusion deposition processes 960 to form objects 965.

As mentioned before, the polyamide 12 powder most commonly used for SLS processing changes properties with exposure to cycles of SLS vat temperatures and tends towards a more crystalline state that adversely affects melt viscosity. In contrast, at least some aperiodic polyamide species which may also be used in an SLS process change by becoming less crystalline when subjected to the repeated temperature cycling of SLS. It has been found that the aperiodic polyamide species may be combined either in virgin form or as post-SLS partcake powder to achieve useful compositions in accordance with the present teachings.

In a reduction to practice, various sample compositions were made in 8 Kg batches, with the latter notable batches comprising the PA12 partcake plus 10%-15% by weight of the aperiodic species and from 30-35% by weight of the carbon fiber filler. Carbon fibers selected as filler were SIGRAFIL® M80 sourced from SGL Carbon SE of Germany. It was noted that used SLS powder partcakes of both the polyamide 12 and the aperiodic polyamide species had some content of coarse grains or small clumps resulting from the SLS processing. However, these minor anomalies were not large enough to prevent homogenous melt processing.

In preparing each experimental batch, the dry ingredients were first mixed in dry form in a blender of a common type that operates by rotating a V-shaped chamber. The dry blend was then melt processed batches through a Theysohn TSK 21 mm Twin Screw Extruder at a throughput rate of between 7 and 10 lb/hr. Extrusion temperature for all zones were nominally set at 200 degrees C. Melt pressure was 75-100 pounds per square inch. Motor speed was between 250-265 RPM. Notably lower extruder torques were experienced with the addition of the aperiodic polyamide species in comparison to earlier measurements with PA12 alone.

Prior to the addition of carbon fibers, the heat of fusion was measured for various blended proportions of the PA12 and aperiodic polymer species. The PA12 alone exhibited a heat of fusion of 47.8 J/g. When the aperiodic species was added to make up 10% of the mass, the heat of fusion was 46.6 J/g. When the aperiodic species was added to make up 20% of the mass, the heat of fusion was 42.8 J/g. DSC data of the blended forms indicated a single unified melt transition indicating miscibility among the two polyamide species.

In terms of successfully creating an extruded part with consistent single-trace stacking and minimal warpage, a notably favorable blend was found comprising 15% by weight of the aperiodic ICP species (sourced from post-SLS partcake), 35% by weight of carbon fiber and 50% by weight of PA12 partcake. Single-perimeter, four-walled sample cubes measuring approximately 30 cm on edge were extruded using a 2.0 mm nozzle and 1.0 mm layer heights.

For comparison, and to explain the selection of a preferred composition, Table I lists a variety of compositions that were produced in the manner described above. As an exception, Blend #4 was concocted by mixing already-pelletized blends to achieve a desired net proportion when liquefied in an extrusion system. For all samples, the ICP species was a polyamide formed by random copolymerization of 6-carbon and 12-carbon cyclic monomers in a ring opening co-reaction.

TABLE I

| Blend ID | % PA12 | % ICP | % CF | % fresh PA12 | % reclaimed |
|---|---|---|---|---|---|
| #1 | 60 | 15 | 25 | 0 | 75 |
| #2 | 55 | 15 | 30 | 0 | 70 |
| #3 | 50 | 15 | 35 | 0 | 65 |
| #4 | 30 | 6 | 25 | 39 | 36 |

For each of the compositions in Table I, a 30 cm single-walled open cube was formed by a pellet-fed extrusion deposition system, namely a model EXT 1070 manufactured by 3D Systems Inc. of Rock Hill, SC. This apparatus produced the parts using a 2 mm diameter nozzle opening and 1 mm layer thickness, with sufficient flow to produce a nominal bead width of 3 mm. Feed rate (lateral nozzle speed) was 5 meters per minute. Four extruder temperature zones were used, progressing from 210°, 220°, 235° and then a final discharge temperature at 235°, all in Celsius degrees.

After being formed and allowed to cool, each cube was cut into four wall panels and then multiple Type I tensile samples, per ATSM D638, were cut from the panels. In particular, for each cube, a first set of samples were cut from a first panel oriented to test what may be termed ‘vertical’, ‘Z-axis’ or ‘interlayer’ tensile properties. For each given cube, a second set of samples were cut from an adjacent second panel (sharing one vertical edge with the first panel from the same cube) to test tensile properties in line with a ‘lateral’ or ‘XY’ axis or in the direction of nozzle travel. For parts formed by extrusion deposition, strength in the vertical direction is frequently less than in the horizontal direction partly because interlayer adhesion relies on a short-lived melding process to occur layer-by-layer. This disparity is especially true for single-bead thickness samples due to the grooves that form between fused layers. The effective cross section of a sample may be less than what can be macroscopically measured by contacting only the outermost bulge of each layer. The small radius grooves create stress risers.

TABLE II

| | | | | Elastic | Elastic | |
|---|---|---|---|---|---|---|
| | | | | Modulus - | Modulus - | |
| | Tensile-Z | Tensile-XY | Tensile | Z | XY | Warp |
| Blend ID | (MPa) | (MPa) | Anisotropy | (MPa) | (MPa) | (mm) |
| #1 | 36.67 ± 0.82 | 62.75 ± 2.86 | 1.71 | 2070 ± 150 | 6110 ± 470 | 5.13 |
| #2 | 33.08 ± 0.59 | 65.87 ± 1.88 | 1.99 | 1985 ± 72 | 7060 ± 248 | 5.52 |
| #3 | 30.00 ± 0.90 | 71.96 ± 1.22 | 2.40 | 1804 ± 99 | 9875 ± 569 | 1.33 |
| #4 | 30.76 ± 1.02 | 78.42 ± 1.44 | 2.55 | 1900 ± 145 | 7267 ± 543 | 1.95 |

Table II shows the results of tensile tests upon the compositions presented in Table I. The tensile strengths listed are ‘ultimate tensile strength’ rather than ‘tensile stress at break’, though these were nearly identical. ‘Tensile anisotropy’ is the ratio of XY-axis tensile strength to Z-axis tensile strength. Warp in millimeters was measured as the maximum deviation away from a straight edge placed along the diagonal of the 30 cm×30 cm wall panels, averaged among two adjacently formed sides. (While the magnitude of vertical warp recorded here may seem excessive, it should be noted that the single bead width 30 cm tall vertical wall of these open-ended test cubes is an exceptionally sensitive test of warp tendency and that some materials exhibiting this behavior in test runs may, in fact, be well suited for more typical constructions involving multiple-bead wall thicknesses and substantial interior infill density.)

Blend #3 was formed by combining two post-SLS species, one being an ICP, and adding 35% carbon fiber filler.

Blend #4 contains some used ICP polymer, but more heavily tries to apply a typical practice of adding virgin material to reuse a highly cycled material. This blend involved adding 39% fresh PA12 and 25% carbon filler to reclaim the remainder of used material at a 36% rate at best. For expediency in compounding from existing blends, a post-SLS aperiodic polyamide species was included as minor component in this blend, but virgin PA12 was mainly relied upon to improve extrudability.

Blends #1, #2 and #3 show a progression of introducing more carbon filler in replacement of spent PA12 while keeping the ICP content constant (and adequate to keep extruder torque acceptably low.) Warpage improves significantly with increasing filler proportion. While lateral tensile strength is also seen to improve with higher filler content, imbalance between Z- and XY-oriented tensile strengths increases as well.

Blend #3, which consumes no fresh thermoplastic stock, favorably compares with Blend #4 in strength, stiffness and print quality (in terms of warping of deposited structures). Importantly, Blend #3 as an example of a successful blend achievable without using any fresh material, is more efficient than Blend #4 at converting spent SLS powder into a form suitable for additive manufacturing by extrusion deposition. The resulting mechanical strength properties are comparable, with Blend #3 exhibiting an ultimate tensile strength 92% as high as Blend #4. Values for stiffness and warp (as a measure of extrusion printing quality) are comparable between these two blends. Visually, Blend #3 demonstrated the ability to achieve exceptionally consistent bead formation over the entire build and a uniform outward matte finish throughout. These are generally regarded as highly desirable aesthetic qualities in this form of manufacture. Printed under the same conditions, Blend #4 showed a somewhat coarse texture due to erratic bead formation, but it was not determined whether nozzle temperature or other parameters could be optimized to improve surface appearance for that specific blend.

Even though the blends in Table I employed post-SLS aperiodic polymer species, it bears reiterating that the present teachings are not limited to just using ‘spent’ post-SLS forms of an ICP species. In some circumstances, economic factors may justify using a mass of fresh ICP species or a mixture of fresh and used ICP species to reclaim a more highly crystallized, non-ICP species. The explained advantages of blend efficiency, lowered extruder torque and excellent extruded print quality, without altering chain structure of a reclaimed species or introducing new functional groups, are still realized in accordance with the present teachings.

Furthermore, while fibrous carbon filler has been found to usefully complement the ICP species in rendering an extrusion-compatible feedstock, filler materials other than carbon and filler shapes other than fibrous may be acceptable substitutes depending on the strength and modulus characteristics needed. A mixture of filler materials and filler particle shapes are also contemplated to suit a given application.

In the preceding description, various principles and exemplary embodiments have been described with reference to the accompanying drawings. It will be evident, however, that various modifications and changes may be made thereto, and additional embodiments may be implemented, without departing from the scope of the invention as set forth in the claims that follow. The description and drawings are, therefore, to be regarded in an illustrative rather than a restrictive sense.

1. A method for adapting a first polymer material to be used as a feedstock for an extrusion deposition additive manufacturing process, the method comprising:
obtaining the first polymer material after it has been used in at least one cycle of a first laser sintering process; and
forming a composition by compounding the first polymer material with a filler and with a second polymer material that has a molecular structure comprising aperiodic spacing of functional groups.

2. The method of claim 1 wherein the composition comprises between 10% and 20% by weight of the second polymer material, between 30% and 40% by weight of the filler and the majority of the balance by weight of the first polymer material.

3. The method of claim 1 wherein the filler comprises carbon fibers.

4. The method of claim 1 further comprising:
supplying the composition as a feedstock in an extrusion deposition additive manufacturing process.

5. The method of claim 1 further comprising:
pelletizing the composition for use by at least one of a pellet-fed extruder in an extrusion deposition system and a filament-forming extruder.

6. The method of claim 1 further comprising:
forming the composition into a filamentous form suitable for consumption by a filament-fed extrusion deposition system.

7. The method of claim 1 wherein the first polymer material comprises unfused powder as a byproduct of the laser sintering process.

8. The method of claim 1 wherein the first laser sintering process causes the first polymer material to increase in crystallinity.

9. The method of claim 1 wherein the second polymer material is obtained after being used in at least one cycle of a second laser sintering process.

10. The method of claim 9 wherein the second laser sintering process causes the second polymer material to decrease in crystallinity.

11. The method of claim 1 wherein the first polymer material comprises one or more regular polyamide species.

12. The method of claim 11 wherein the first polymer material comprises at least one of polyamide 12 and polyamide 11.

13. The method of claim 1 wherein the first polymer material and second polymer material have a polar functional group in common.

14. The method of claim 13 wherein the common polar functional group is an amide moiety.

15. The method of claim 1 wherein, in the molecule structure of the first polymer material, the polar functional group and methylene groups occur in a repeating pattern along each polymer chain.

16. The method of claim 1 wherein the first polymer and second polymer are polyamides and wherein molecules of the first polymer comprise a repeating pattern of amide functional groups and methylene units and wherein molecules of the second polymer comprise randomly varying quantities of methylene groups between amide functional groups.

17. The method of claim 1 wherein both the first polymer and second polymer are polyamides and wherein molecules of the first polymer material comprise a consistent repeating pattern of amide functional groups and methylene units and wherein molecules of the second polymer comprise random occurrences of either a first quantity of methylene units or a second quantity of methylene units between each pair of amide functional groups.

18. A polymeric composition as a feedstock for an extrusion deposition additive manufacturing process comprising:
a first polymer that has been subjected to elevated temperatures during at least one cycle of a selective laser sintering process;
a second polymer comprising a molecular structure with irregular spacings between functional groups separated by methylene units; and
a filler material.

19. The polymeric composition of claim 18 wherein the polymeric composition comprises between 10% and 20% by weight of the second polymer material, between 30% and 40% by weight of the filler material and the majority of the balance by weight of the first polymer material.

20. The polymeric composition of claim 18 wherein the filler comprises carbon fibers.

21. The polymeric composition of claim 18 wherein the first polymer material is of a molecular structure comprising a repeating pattern of at least one first species of polar functional group and at least one methylene group positioned between occurrences of the polar functional group.

22. The polymeric composition of claim 18 wherein the polar functional group is an amide functional group.

23. The polymeric composition of claim 18 wherein the first polymer material and second polymer material are polyamides and wherein molecules of the first polymer material comprise a repeating pattern of amide functional groups and methylene units and wherein molecules of the second polymer material comprise randomly varying quantities of methylene groups between amide functional groups.

24. The polymeric composition of claim 23 wherein the first polymer material comprises at least one of polyamide 12 and polyamide 11 and wherein the second polymer material comprises a copolymer formed by random copolymerization of a 6-carbon monomer and a 12-carbon monomer.

25. An article of manufacture for use as a feedstock in an extrusion deposition process comprising:
a composition comprising:
at least one first polymer material that has been subjected to at least one cycle of a selective laser sintering process;
at least one second polymer material wherein functional groups occur at irregular intervals along the molecules; and
a filler;
wherein the composition is formed into a shape suitable for input to an extruder of an extrusion deposition additive manufacturing system.

26. The article of manufacture of claim 25 wherein the shape is one among the group consisting of a round filament, a flat ribbon and a pellet.

27. The article of manufacture of claim 25 wherein the molecules of the first polymer material comprise functional groups occurring in a repeating pattern.

28. The article of manufacture of claim 25 wherein the filler is carbon fiber.

29. The article of manufacture of claim 25 wherein the first polymer material and the second polymer material are polyamides.

30. The article of manufacture of claim 29 wherein the filler is carbon fiber.
